(19) United States
(12) Patent Application Publication
(10) Pub. No.: US 2005/0132244 A1
(43) Pub. Date: Jun. 16, 2005

(54) Byte alignment method and apparatus

(75) Inventor: David Russell Milway, Cottenham (GB)

Correspondence Address: JONES DAY, 222 EAST 41ST ST, NEW YORK, NY, 10017, US

(73) Assignee: Virata Limited

(21) Appl. No.: 10/772,580

(22) Filed: Feb. 4, 2004

Related U.S. Application Data
(63) Continuation of application No. 09/529,739, filed on Jun. 26, 2000, now abandoned.

(30) Foreign Application Priority Data
Nov. 13, 1997 (GB) GB 9724027.9

(51) Int. Cl. G06F 13/42

(52) U.S. Cl. 713/400

(57) ABSTRACT

The method and apparatus correct for byte misalignment in a block of data. Switch means are set to perform a switching cycle depending on the amount of byte misalignment. Each word in the block is then transferred in accordance with the switching cycle, so that the bytes are aligned by the transfer, the aligned bytes then being stored. A first word in the data block is transferred into an input register where the amount of byte misalignment is determined in order to control the switching cycle, i.e. when the words are transferred to an output register. Also disclosed is a method of translating the encapsulation of a protocol labeled data block by removing an original header and original trailer from the data block, providing a new header and a new trailer and using the byte alignment method to determine any byte misalignment in the new header or trailer. The new header, new trailer and the original data block are transferred into storage with any necessary shift in the data block to compensate for the byte misalignment.

This invention relates to a method and apparatus for aligning bytes in a block of data consisting of a plurality of words, each consisting of predetermined number of bytes of predetermined bit length. The invention finds particular, (but not exclusive use) in aligning bytes on a word boundary during a block data transfer, for example, at an interface between memory and peripheral devices in computer systems. The byte alignment method can also be used with advantage in translating the encapsulation of a protocol labelled data block, for example, in switching data from Ethernet to ATM.

Where network software performs protocol conversions, headers and trailers in the protocol labels can be modified and bytes can thereby become misaligned with a word boundary. This can slow up a data transfer. By way of example, in a computer system having a processor with a word size of 32 bits, a 32-bit wide memory and a 32-bit wide memory to network interface, (e.g. as in an ATM network where a basic transmission operation sends an ATM cell by writing thirteen 32-bit words to the interface), the transfer will be efficient when the data to be transmitted is aligned on a word boundary in memory. In this case, the processor initiates a data transfer and each word will be copied from memory to the network device. However, if the data is aligned with an arbitrary byte boundary, rather than a word boundary, transfer will be slower. The processor must then either copy and then re-align the data before starting the transfer operation, or it must construct and write the words individually to the network device.

The invention seeks to solve the foregoing problem. At least in a preferred embodiment, it may be considered as an enhancement to data transfer that enables a byte to be shifted in order to be aligned bytes with a word boundary prior to or during the transfer.

WO-A-94/07199 implements a two stage sort and requires the use of individual byte lane valid bits for operation. This results in the output word (32 bits) having possible invalid bytes within the stream. The intention is to allow arbitrary streams of DMA data to be re-aligned with minimal processor intervention. EP-A-94304589.8 incorporates byte alignment logic into a peripheral itself and the byte alignment logic is similar to the WO-A-94/07199 byte lane valid bits, but it also has individual mask bits supplied by some external control logic. U.S. Pat. No. 5,168,561 discloses byte alignment technique which uses a carrier register and a data selector with four 4:1 multiplexers.

Features of the invention are defined by the attached claims.

The invention can be embodied, in practice, so that:
(i) an output data stream, 32 bits wide, is always aligned to a word boundary;
(ii) an offset, stored in the unused byte portion of the input (or residue) register, is always loaded into the input (or residue) register; and
(iii) the offset and input (or residue) register are readable by a processor which implements the method of the invention

This provides a rapid way to re-align multiple different streams of data all of which are on different boundaries.

The byte alignment method of the invention can be advantageously used in translating the encapsulation of a protocol labelled data block by the steps of:
removing an original header from the data block;
providing a new header;
using the byte alignment method to determine any byte misalignment in the new header; and
transferring the new header and the original data block into storage with any necessary byte shift in the data block to compensate for the byte misalignment.

In the latter method, the old trailer can also be removed and replaced with a new trailer whereby the byte alignment method is also used to determine any byte misalignment in the new trailer as well as in the new header. The new header, the original data block and the new trailer are then transferred (into storage) with any necessary byte shift in the data block to compensate for the byte misalignment.

The advantage of such method of translation is that there is no unnecessary copying of the data block.

The latter method can be incorporated in suitable apparatus having respective means for carrying out the steps of the method.

A preferred embodiment of the invention will now be described with reference to the accompanying drawings, in which:

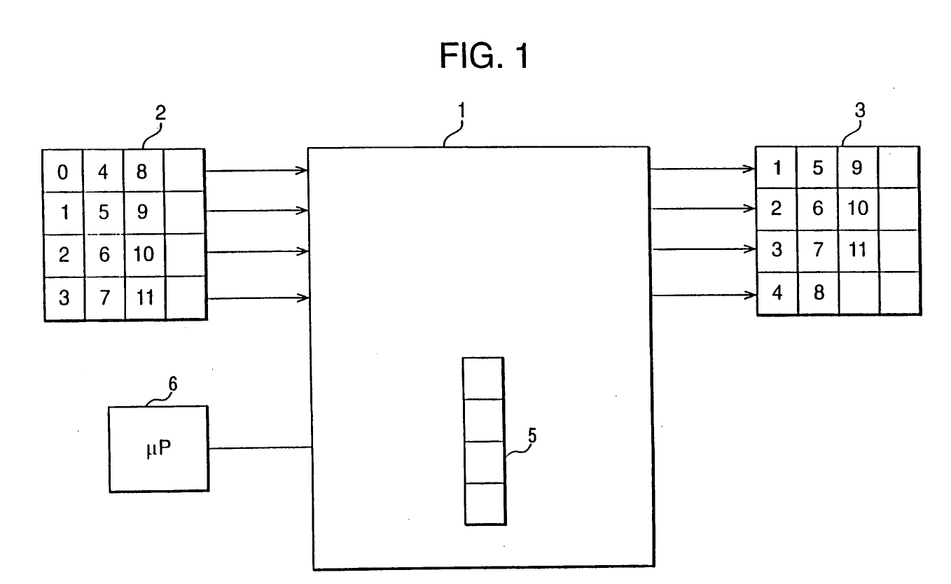

FIG. 1 is a block diagram of circuitry for correcting byte misalignment;

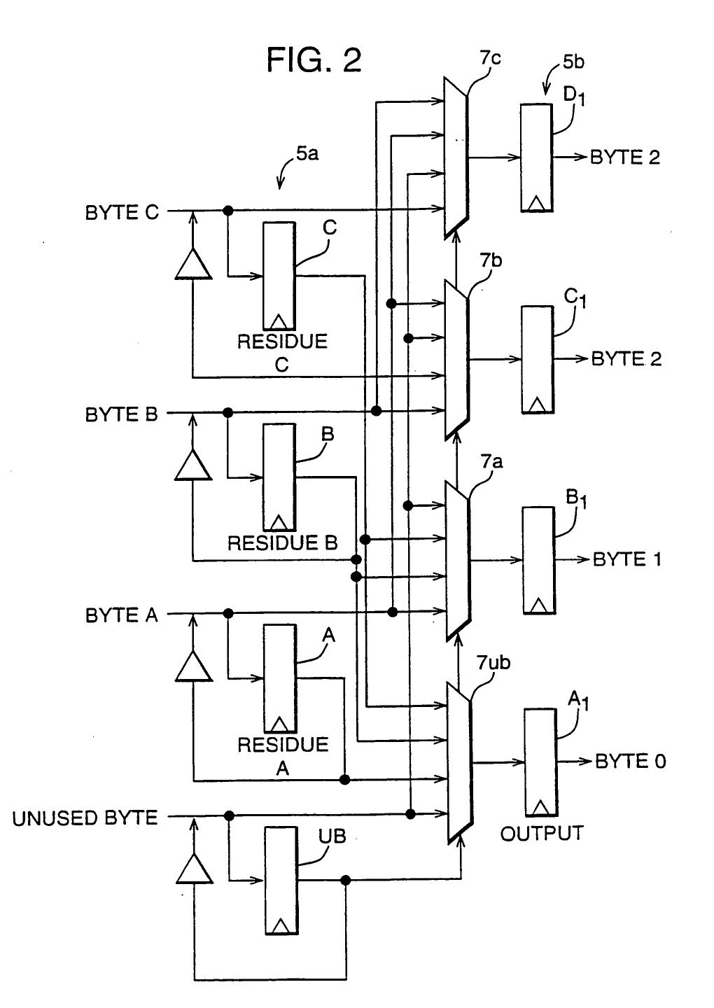

FIG. 2 is a schematic diagram of a register used in the circuitry of FIG. 1;

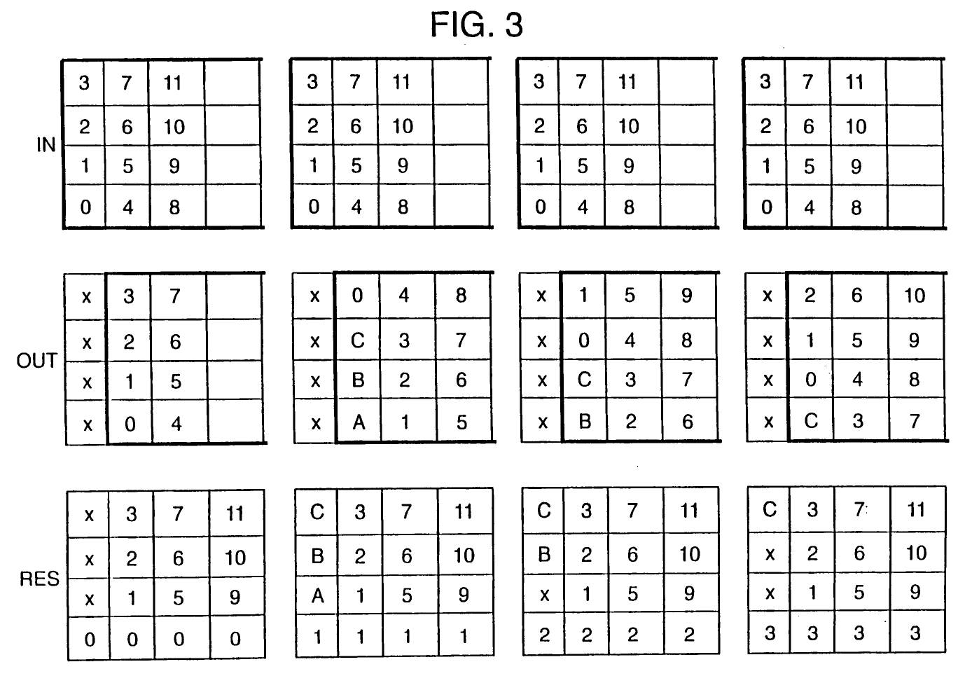

FIG. 3 illustrates the byte alignment logic;

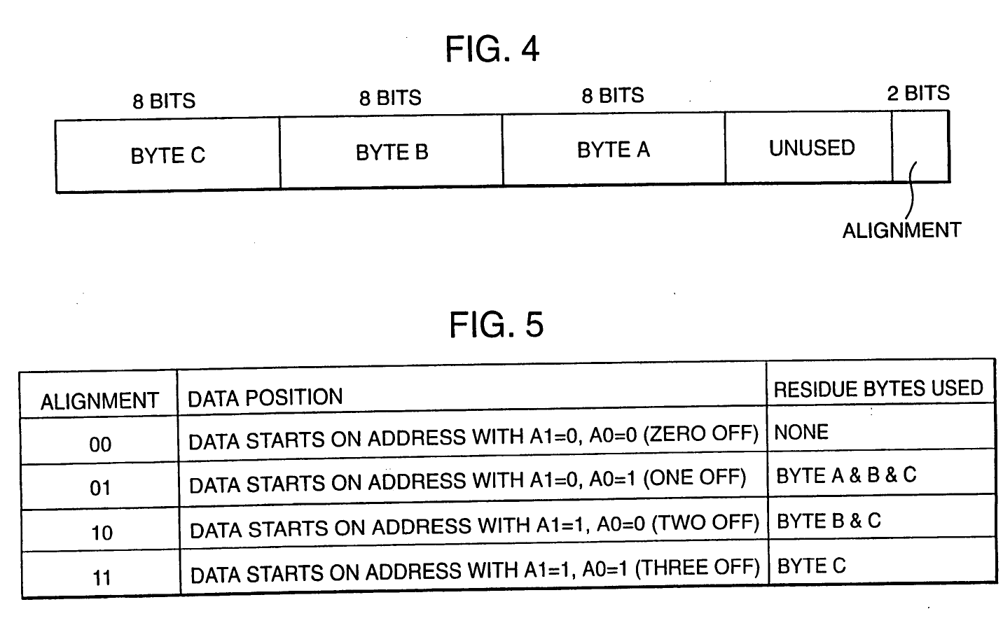

FIG. 4 illustrates the byte positions in an input stage of the register;

FIG. 5 is a table drawing the relationship between alignment bits and the amount of byte misalignment; and

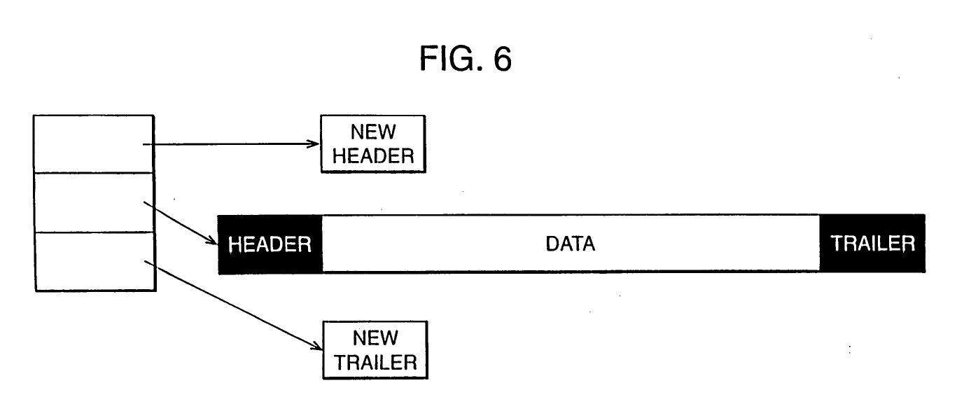

FIG. 6 illustrates how the byte alignment logic can be applied in a method of translating the encapsulation of a protocol labelled block of data.

FIG. 1 schematically illustrates a memory 1 having an input buffer 2 equipped with a read pointer for reading data into the memory, and an output buffer 3 having a write pointer which enables data to be written into the output buffer 3. In the example illustrated, the data in the input buffer 2 is not aligned, since a gap, represented by an “O” appears in the first byte position and the first byte “1” of data appears in the second byte position (in the first column of the input buffer). The first four bytes 1, 2, 3, 4 of data are shown aligned in the output buffer 3. The memory 1 includes a byte alignment register 5 which is described in more detail below. A microprocessor 6 controls the operation of the system.

FIG. 2 illustrates the byte alignment register 5 in more detail and FIG. 3 illustrates the byte alignment logic. FIG. 4 shows (in this example only) 4 byte positions in an input stage 5a of the register 5. These are C, B, A and UB (i.e. an unused byte position). The first four bytes in the data block in the input buffer 2 are shifted into the input stage 5a of the byte alignment register, so that the byte positions C, B, A, UB will contain bytes 3, 2, 1, O of the data block. The unused byte position UB will contain O which represents byte misalignment. The amount by which the byte is misaligned with the word boundary is determined in the unused position UB. In the illustrative example, each byte position contains 8 bits and in the unused byte position UB, two bits are used for directing alignment. For example, if the byte misalignment is “one” bit, two alignment bits 01 are stored in position UB. These bits are used, by the processor 6, to control the operation of switching means 7c, 7b, 7a, 7ub so as to correct the byte misalignment. After shifting the first four bytes back out of input register 5a, the processor adds excess bits to position UB to make up an 8 bit byte with the two alignment bits. The first three words of the data block are then shifted into positions A, B, C in the input stage, where they are transferred into positions D₁, C₁, B₁ in output stage 5b of the byte alignment register 5, thereby correcting the misalignment. The alignment bits O1 remaining in position UB serve to direct the subsequent fourth word (which is “4”) into position A₁ in the output stage 5b. After transferring the first four bytes from the input buffer 2 into the output buffer 3, the alignment bits (01) remaining in position UB cause the processor to direct each set of four subsequent bytes of the data block (in the input buffer 2) into the output stage 5b, i.e. in accordance with the same 3 byte, 1 byte switching cycle or pattern. In this way, the whole input block is transferred, with alignment, to the output buffer 3.

It can be seen in FIG. 5 that alignment bits 10 and 11 will respectively shift the input bytes by 2 and 3 byte positions, the processor 6 controlling the operation of the switching means 7c, 7b, 7a, 7ub in accordance with the 2 byte, 2 byte or 1 byte, 3 byte pattern. The processor 6 will insert excess bits into the unused bit positions in position UB of the input register 5a so as to complete the 8 bits (i.e. 2 alignment bits and 6 excess bits). FIG. 4 shows the alignment logic in more detail and FIG. 5 shows the relationship between the alignment bite and data position.

A further example of the mode of operation is given below (in which there is a one byte misalignment) in which misalignment bits 01 control the switching operation.

### EXAMPLE

The diagrams show consecutive bytes in memory, with each column being the bytes of one word starting on a 32-bit address boundary.

Data starts at ‘address mod 4=1’:

Data to transmit

| | | | | |
|---|---|---|---|---|
| 1 | 4 | 8 | 12 | etc. |
| 1 | 5 | 9 | 13 | |
| 2 | 6 | 10 | 14 | |
| 3 | 7 | 11 | 15 | |

The alignment register is then loaded with the values 1, 2 and 3 (the bytes before the first word boundary) and the offset value 1.

| | |
|---|---|
| Alignment | |
| reg. | Data to transmit |

| | | | | |
|---|---|---|---|---|
| 1 | 4 | 8 | 12 | etc. |
| 1 | 5 | 9 | 13 | |
| 2 | 6 | 10 | 14 | |
| 3 | 7 | 11 | 15 | |

| Alignment | Data to | | | |
|---|---|---|---|---|
| reg. | transmit | | | Data output |
| 1 | 8 | 12 | etc. | 1 |
| 5 | 9 | 13 | | 2 |
| 6 | 10 | 14 | | 3 |
| 7 | 11 | 15 | | 4 |

After transferring the second word the data looks like:

| | | |
|---|---|---|
| Alignment | Data to | Data |
| reg. | transmit | output |

| | | | | |
|---|---|---|---|---|
| 1 | 12 | etc. | 1 | 5 |
| 9 | 13 | | 2 | 6 |
| 10 | 14 | | 3 | 7 |
| 11 | 15 | | 4 | 8 |

The byte alignment register of the invention is useful in handling network protocols in computer systems, and more particularly in the translation of the encapsulation of a protocol data block without unnecessary copying of the enclosed data.

Consider a computer system connected to one or more networks, and running protocol bridging or routing software. The computer system has a processor with a word size of 32 bits, 32-bit wide memory, and 32-bit wide Direct Memory Access (DMA) interfaces to its network ports.

Each bridging or routing operation involves:
1. receiving a protocol packet from a network port
2. looking up its designation address to determine its target port and protocol
3. if necessary, converting the packet format to the new protocol encapsulation
4. transmitting the packet on the destination port

Step 3 can account for a high proportion of the total processor time spent dealing with the packet. The format conversion may be necessary either because the source and destination networks are of different hardware types (e.g. Ethernet and ATM) or because they are different virtual networks on the same physical layer (e.g. IP on LANE Emulation and Classical IP, both running over ATM).

In general, a network packet (for example an Ethernet frame or an IP packet) consists of a protocol header, the data being transported, and a protocol trailer, laid out in memory as shown:

| | | |
|---|---|---|
| HEADER | DATA | TRAILER |

After the packet has passed through the bridge or router, it contains exactly the same data, but may have a new header and trailer (with changed sizes) corresponding to the new protocol encapsulation:

| | | |
|---|---|---|
| NEW | DATA | NEW |
| HEADER | | TRAILER |

There are two main methods known in the prior art for arranging to transmit the reformatted packet:
1. By copying.
   A new memory buffer is allocated. The new header is constructed in the buffer, the data is copied in from the original packet, and the new trailer is added, forming the new packet in contiguous memory as shown above. This is straightforward, but is inefficient because all data is copied in memory as it passes through the bridge or router.
2. Scatter/gather.
   The new header and trailer are constructed in separate buffers, and a structure is passed to the transmission port containing pointers to the new header, the original data, and the new trailer. The transmission port driver works from these three buffers to reassemble the complete packet as it writes to the network.

The scatter/gather method is efficient, but cannot be used directly on a computer system which has memory and I/O organised as 32-bit words. Since the original packet was received starting on a word memory boundary, the data within it may not be on a word boundary. Also, the new header and trailer may not be an exact number of words in length. Thus the new packet cannot be transmitted directly via the 32-bit DMA interface to the network.

An embodiment of the invention allows the transmission to be handled efficient as follows. Assume the new header and trailer are constructed starting on word boundaries:
1. Set the residue register to zero and transfer (by DMA) the whole words in the New Header.
2. Set the residue register according to the bytes left over from the New Header and the alignment of the start of the Data. (It may be simpler to copy a few bytes from the Data to the end of the New Header, to ensure that the New Header contains a whole number of words.)
3. Transfer the whole words in the Data.
4. Set the residue register from the remaining part of the Data and the start of the Trailer. (Again, copying a few bytes to the start of the Trailer may simplify this.)
5. Transfer enough words to include the last byte of the Trailer.

Further refinements are possible. For example, the New Header could be constructed so that it ended on an alignment complementary to that of the start of the Data, and the Trailer could be aligned to match the end of the Data. By copying the odd bytes from the start and end of the Data to the New Header and Trailer respectively, the whole transfer could be completed as 3 DMA operations with no intermediate adjustments of the residue register.

1. A method of aligning bytes on a word boundary including the steps of:
storing a block of data, containing bytes which are not aligned with a word boundary, in an input register (5a);
determining the amount of byte misalignment with respect to the word boundary;
transferring bytes from the input register (5a) to an output register (5b), under control of a processor (1, so as to correct the byte misalignment; and
repeating the method on subsequent words in the data block until the data block has been transferred with alignment from an input buffer(2) to an output buffer (3);
characterised in that the processor(1):
(a) shifts the first n bytes of said data block into said input register (5a) in order to read the amount of byte misalignment or offset in an unused byte position of the input register (5a);
(b) shifts said n bytes out of said input register (5a) and adds one or more alignment offset bits and excess bits to said unused byte portion of the input register (5a), which offset bits specify the position of the word boundary, and which excess bits make up the byte in the unused byte portion; and
(c) reads the offset bits and excess bits in the unused byte position of the input register (5a) so as to correct for misalignment when transferring bytes from the input buffer (2) to the output buffer (3).

2. A method according to claim 1, when used to translate the encapsulation of a protocol labelled data block, wherein the data block includes a header, and the method includes the steps of:
removing an original header from the data block;
providing a new header;
using the steps of claim 1 to determine any byte misalignment in the new header; and
transferring the new header and the original data block into storage with any necessary shift in the data block to compensate for the byte misalignment.

3. A method according to claim 2, in which an old trailer is also removed and replaced with a new trailer, the byte alignment method of claim 1 being used to determine any byte misalignment in the new header and in the new trailer; the new header, the original data block and the new trailer being transferred with any necessary shift in the data block to compensate for the byte misalignment.

4. Circuitry for aligning data on a word boundary, the circuitry including:
input buffer means (2) for storing a block of data including words containing bytes which are not aligned with the word boundary;
output buffer means (3) for storing words containing bytes which have been aligned with a word boundary; and a processor (1) for controlling the transfer of bytes from an input register (5a) to an output register (5b) so as to correct for the byte misalignment;
characterised in that the processor(1):
(a) shifts the first n bytes of said data block into said input register (5a) in order to read the amount of byte misalignment or offset in an unused byte position of the input register (5a);
(b) shifts said n bytes out of said input register (5a) and adds one or more alignment offset bits and excess bits to an unused byte portion of the input register (5a), which offset bits specify the position of the word boundary, and which excess bits make up the byte in the unused byte portion; and
(c) reads the offset bits and excess bits in the unused byte position of the input register (5a) so as to correct for misalignment when transferring bytes from the input buffer (2) to the output buffer (3).(a) input and output register means for storing n bytes of the data block;

5. Apparatus according to any of claim 4, further including means for removing an original header from a protocol labelled data block; means for providing a new header; means for determining any byte misalignment in the new header and for transferring the new header and the original data block into storage with any necessary shift in the data block to compensate for the byte misalignment.

6. Apparatus according to claim 5, in which means also included for removing an old trailer from the data block, for providing a new trailer and for determining any byte misalignment in the new header and the new trailer; the new header, new trailer and original data block being transferred into storage with any necessary shift in the data block to compensate for the byte misalignment.

7. Apparatus according to claim 5 or 6 in which the new header is constructed so that it ends on a word boundary which is complementary to that of the start of the data block and the trailer is aligned so as to match the end of the data block.

8. Apparatus according to claim 5 or 6 in which odd bytes are copied from the start and end of the data block to the new header and trailer respectively.
